(19) United States
(12) Patent Application Publication
(10) Pub. No.: US 2024/0285380 A1
(43) Pub. Date: Aug. 29, 2024

(54) DENTAL CLEANING DEVICE

(71) Applicants: Xindi WEI, Shanghai (CN); Shuai MA, Xinjiang (CN)

(72) Inventors: Xindi WEI, Shanghai (CN); Shuai MA, Xinjiang (CN)

(21) Appl. No.: 18/434,460

(22) Filed: Feb. 6, 2024

(30) Foreign Application Priority Data
Feb. 23, 2023 (CN) 202310156792.0
May 4, 2023 (CN) 202321023512.0
May 4, 2023 (CN) 202321034884.3

(51) Int. Cl. A61C 17/22; A46B 5/00; A46B 11/00; A46B 11/06; A46B 13/02; A46B 13/04; A46B 15/00; A61C 17/34; A61C 17/36; B01F 23/40; B01F 23/43; B01F 27/112; B01F 35/21; B01F 35/221; B01F 35/32; B01F 35/71; B01F 35/82; B01F 35/83; B01F 101/19

(52) U.S. Cl. CPC A61C 17/221; A46B 5/00; A46B 11/0072; A46B 11/063; A46B 13/023; A46B 13/04; A46B 15/0004; A61C 17/227; A61C 17/3481; A61C 17/36; B01F 23/43; B01F 23/483; B01F 27/112; B01F 35/2111; B01F 35/2211; B01F 35/32025; B01F 35/7176; B01F 35/82; B01F 35/831; A61C 2204/002; B01F 2101/19

(57) ABSTRACT

Provided is a dental cleaning device. In the device, by arranging the water pump, the mixing mechanism and the rotating blade, clean water in the water tank enters the input pipe through the first hose and the three-way valve under the action of the water pump, and toothpaste in the toothpaste chamber also enters the input pipe through the three-way valve under the action of the toothpaste pump, and the mixture of clean water and toothpaste enters the mixing chamber through the input pipe to drive the rotating blade to rotate, so that toothpaste and water may be fully mixed, and toothpaste may be effectively prevented from being blocked in the electric toothbrush.

### FIELD OF THE INVENTION

The present disclosure relates generally to the technical field of dental cleaning, and in particular to a dental cleaning device.

### BACKGROUND

Through the rapid rotation or vibration of the motor core, the toothbrush head of the electric toothbrush generates high-frequency vibration, instantly decomposes the toothpaste into fine foam, and deeply cleans the gap between teeth. At the same time, the vibration of the brush hair may promote the blood circulation in the mouth and massage the gum tissue. In order to make electric toothbrushes more time-saving and labor-saving, there are constantly water-jet electric toothbrushes on the market. The water-jet electric toothbrushes may absorb clean water from the water tank before spraying water from the nozzle at the bristles, making it convenient to brush teeth.

The water-jet electric toothbrushes also have the function of spraying toothpaste at the same time, but the water-jet electric toothbrushes on the market lack the device for mixing toothpaste and water. If the toothpaste and water are not mixed fully, the cleaning effect may be affected, and the toothpaste may be blocked in the electric toothbrushes, resulting in damage to the electric toothbrushes.

### SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key nor critical elements of all embodiments, nor delineate the scope of any or all embodiments.

The present disclosure, in one or more embodiments, relates to a dental cleaning device. In one embodiment herein, the dental cleaning device includes an electric toothbrush and a mixing mechanism, where the electric toothbrush is connected to the mixing mechanism.

In one embodiment herein, the electric toothbrush includes a toothbrush shell and a perforated toothbrush head, the perforated toothbrush head is arranged at a top of the toothbrush shell, a water pump and a vibration motor are arranged in the toothbrush shell, the vibration motor is internally provided with an annular cavity rod penetrating the vibration motor, the water pump is communicated with the annular cavity rod through a pipeline, a top of the annular cavity rod is inserted into a bottom of the perforated toothbrush head and the perforated toothbrush head is communicated with the annular cavity rod.

In one embodiment herein, the mixing mechanism includes a base, a water tank, a three-way valve, a toothpaste chamber, a toothpaste pump, and a mixing chamber; the mixing chamber is arranged in the base, and the mixing chamber is respectively provided with an input pipe and an liquid output pipe; the water tank is arranged at a top of the base, the water tank is internally provided with a water outlet, and the water outlet is connected to a water inflow port of the three-way valve through a first hose; the toothpaste chamber is arranged in the base, a discharge port of the toothpaste chamber is connected to an input end of the toothpaste pump, and an output end of the toothpaste pump is connected to a toothpaste inflow port of the three-way valve through a second hose; an outflow port of the three-way valve is connected to the input pipe of the mixing chamber, and the electric toothbrush is arranged on the base.

Further, an upper cover bracket is arranged on the mixing chamber, and a surface of the upper cover bracket is provided with a through hole, one end of the liquid outlet pipe is connected to an inside of the mixing chamber through the through hole, another end of the liquid outlet pipe is connected with a third hose, and the third hose is connected to an input end of the water pump. Further, an inner side of the upper cover bracket is rotatably connected to a rotating shaft, and an end of the rotating shaft is connected to a rotating blade.

In one embodiment herein, the rotating blade includes an annular ring, an outer side of the annular ring is provided with sub blades, a transverse plate is provided on the annular ring, magnets are symmetrically arranged at one end of the transverse plate near a Hall sensor, a protective cover is provided on an outer side of the upper cover bracket, and the Hall sensor is arranged inside the protective cover.

In one embodiment herein, the toothbrush shell is provided with a button for controlling start and stop of the water pump, vibration motor, and toothpaste pump. Further, a first battery is provided in the base for supplying power to the toothpaste pump, and a second battery is provided in the toothbrush shell for supplying power to the water pump and the vibration motor.

In one embodiment herein, the dental cleaning device further includes a water flow sensor and a first control chip, where the water flow sensor is arranged on the water inflow port of the three-way valve, the water flow sensor is connected to the first control chip, and the first control chip is connected to the first battery.

In one embodiment herein, the water flow sensor detects a water flow signal and transmits the water flow signal to the first control chip, the first control chip controls the start and the stop of the toothpaste pump based on a ratio of a working duration of the water flow signal to a preset time value, and the first control chip also controls working power of the toothpaste pump based on an amplitude of the water flow signal.

In one embodiment herein, the water pump is connected to a second control chip, and the second control chip is connected to the second battery. Further, a second control chip controls a frequency and an operating mode of the water pump, and the first control chip stores different preset values of a water flow rate and frequency signal; when the first control chip obtains a water flow signal meeting one of the preset values of the water flow rate and frequency signal, the second control chip outputs corresponding control instructions.

Compared with the prior art, the embodiments have the following beneficial effects. By arranging the water pump, the mixing mechanism and the rotating blade, clean water in the water tank enters the input pipe through the first hose and the three-way valve under the action of the water pump, and toothpaste in the toothpaste chamber also enters the input pipe through the three-way valve under the action of the toothpaste pump, and the mixture of clean water and toothpaste enters the mixing chamber through the input pipe to drive the rotating blade to rotate, so that toothpaste and water may be fully mixed, and toothpaste may be effectively prevented from being blocked in the electric toothbrush. By the toothpaste pump to deliver toothpaste, the process of squeezing toothpaste by users may be omitted, and toothpaste is prevented from being washed away by water flow on the bristles, which is convenient for brushing teeth and saves time.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a schematic view of a three-dimensional structure of a dental cleaning device, in accordance with embodiments of the invention.

FIG. 2 illustrates a schematic structural diagram of the mixing mechanism of the dental cleaning device, in accordance with embodiments of the invention.

FIG. 3 illustrates a schematic diagram of the internal structure of the electric toothbrush, in accordance with embodiments of the invention.

FIG. 4 illustrates an enlarged structural schematic diagram of the electric toothbrush, in accordance with embodiments of the invention.

FIG. 5 illustrates a schematic diagram of the internal structure of the mixing mechanism, in accordance with embodiments of the invention.

FIG. 6 illustrates a schematic structural diagram of the mixing chamber, in accordance with embodiments of the invention.

FIG. 7 illustrates a schematic diagram of the exploded structure of the mixing chamber, in accordance with embodiments of the invention.

FIG. 8 illustrates a schematic side sectional view of the mixing chamber of the present application at the position of the input pipe, in accordance with embodiments of the invention.

FIG. 9 illustrates a connection diagram of the first control chip, in accordance with embodiments of the invention.

FIG. 10 illustrates a connection diagram of the second control chip, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

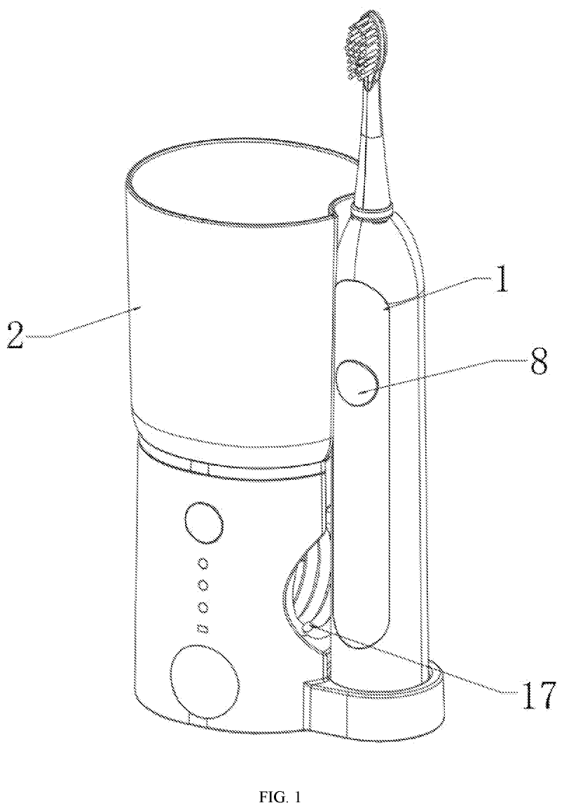

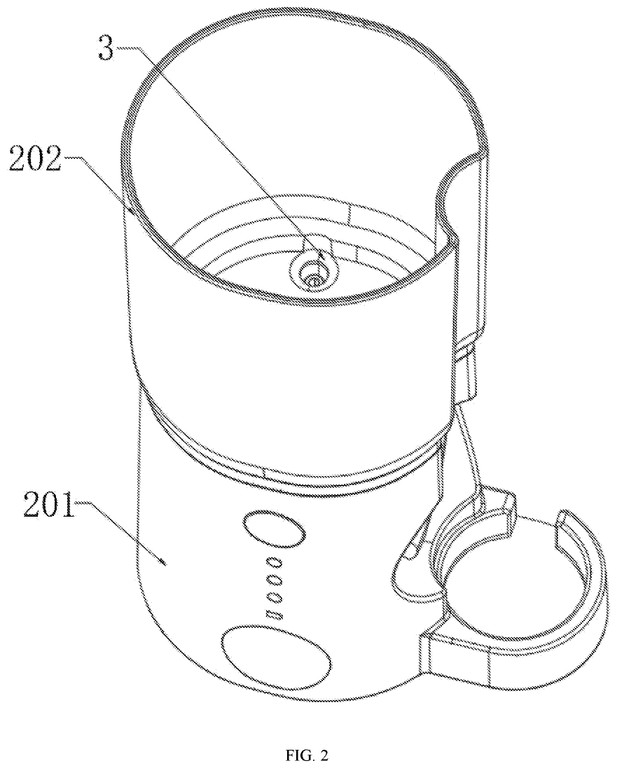

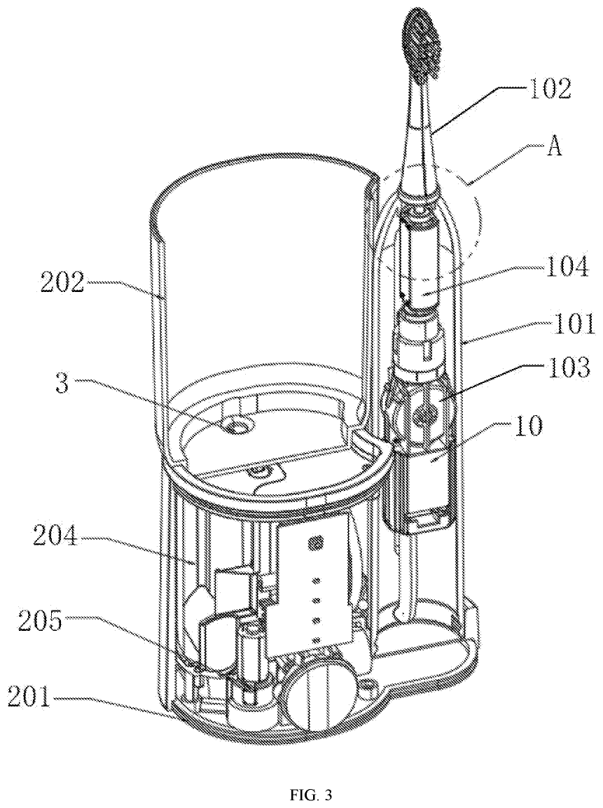

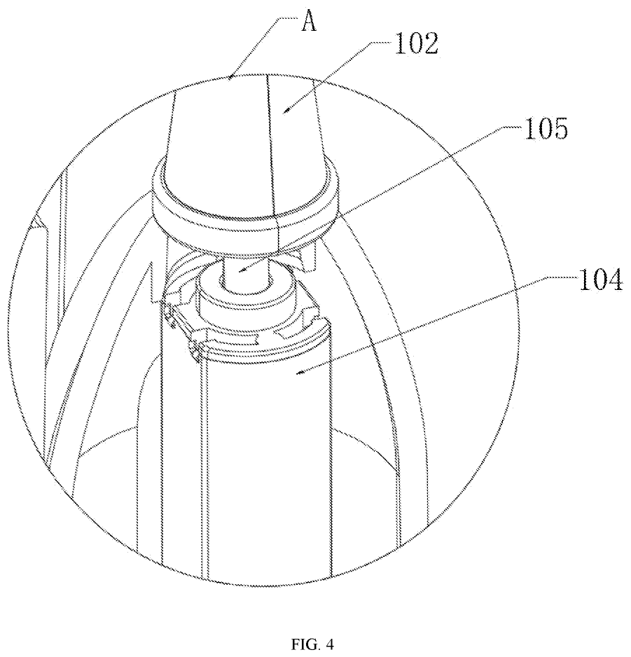

FIG. 1 refers to a schematic view of a three-dimensional structure of a dental cleaning device. The dental cleaning device includes an electric toothbrush 1 and a mixing mechanism 2, and the electric toothbrush 1 is connected to the mixing mechanism 2. As shown in FIG. 2 to FIG. 4, the electric toothbrush 1 includes a toothbrush shell 101 and a perforated toothbrush head 102, where the perforated toothbrush head 102 is arranged at a top of the toothbrush shell 101, a water pump 103 and a vibration motor 104 are arranged in the toothbrush shell 101, the vibration motor 104 is internally provided with an annular cavity rod 105 penetrating the vibration motor 104, the water pump 103 is communicated with the annular cavity rod 105 through a pipeline, a top of the annular cavity rod 105 is inserted into a bottom of the perforated toothbrush head 102 and the perforated toothbrush head 102 is communicated with the annular cavity rod 105.

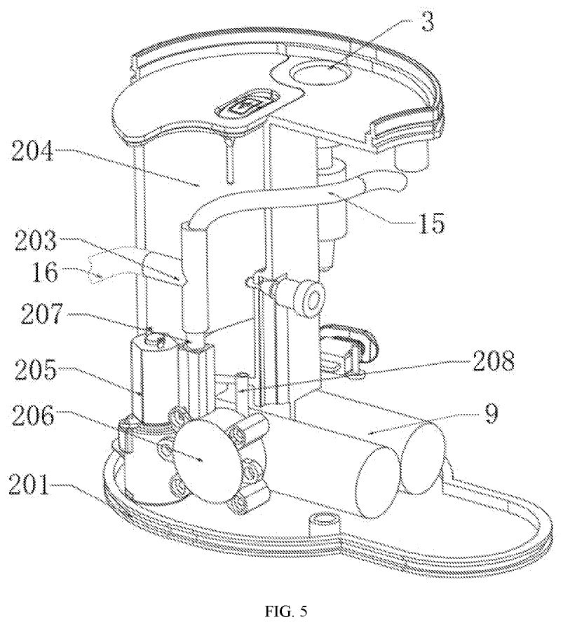

As shown in FIG. 2 to FIG. 5, the mixing mechanism 2 includes a base 201, a water tank 202, a three-way valve 203, a toothpaste chamber 204, a toothpaste pump 205, and a mixing chamber 206; the mixing chamber 206 is arranged in the base 201, and the mixing chamber 206 is respectively provided with an input pipe 207 and an liquid output pipe 208; the water tank 202 is arranged at a top of the base 201, the water tank 202 is internally provided with a water outlet 3, and the water outlet 3 is connected to a water inflow port of the three-way valve 203 through a first hose 15; the toothpaste chamber 204 is arranged in the base 201, a discharge port of the toothpaste chamber 204 is connected to an input end of the toothpaste pump 205, and an output end of the toothpaste pump 205 is connected to a toothpaste inflow port of the three-way valve 203 through a second hose 16; an outflow port of the three-way valve 203 is connected to the input pipe 207 of the mixing chamber 206, and the electric toothbrush 1 is arranged on the base 201.

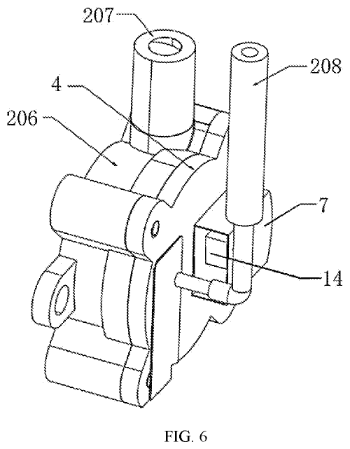

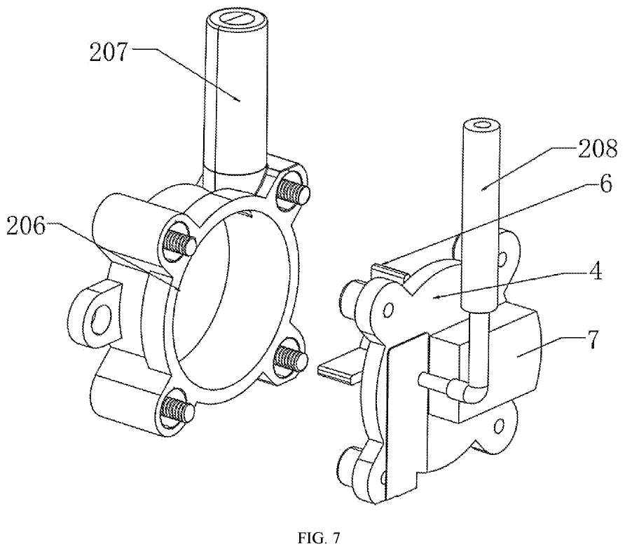

As shown in FIG. 6 to FIG. 8, an upper cover bracket 4 is arranged on the mixing chamber 206, and a surface of the upper cover bracket 4 is provided with a through hole 5, one end of the liquid outlet pipe 208 is connected to an inside of the mixing chamber 206 through the through hole 5, another end of the liquid outlet pipe is connected with a third hose 17, and the third hose 17 is connected to an input end of the water pump 103. An inner side of the upper cover bracket 4 is rotatably connected to a rotating shaft, and an end of the rotating shaft is connected to a rotating blade 6. Clean water in the water tank 202 enters the input pipe 207 through the first hose 15 and the three-way valve 203 under the action of the water pump 103, and toothpaste in the toothpaste chamber 204 also enters the input pipe 207 through the three-way valve 203 under the action of the toothpaste pump 205, and the mixture of clean water and toothpaste enters the mixing chamber 206 from the input pipe 207 to drive the rotating blade 6 to rotate, so that toothpaste and water may be fully mixed, and toothpaste may be effectively prevented from being blocked in the electric toothbrush 1.

In one embodiment herein, the rotating blade 6 is mechanically driven by water flow, and in this way, cost may not be increased. In other embodiments, the rotating blade 6 may be driven mechanically by increasing external force.

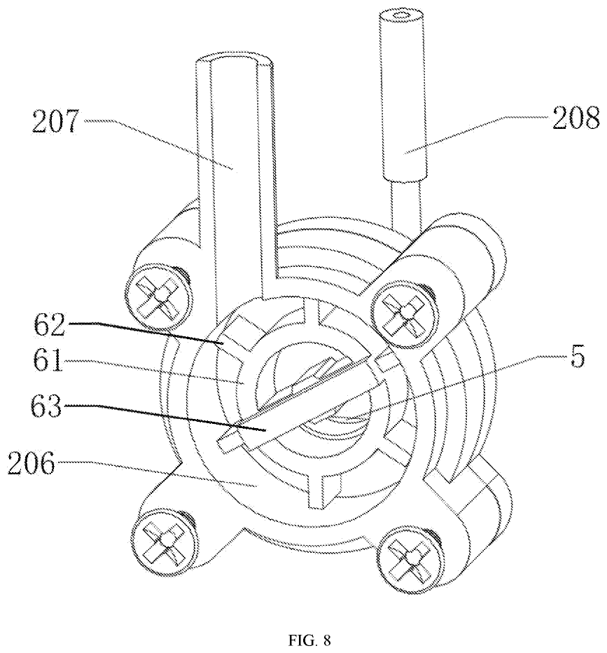

FIG. 8 illustrates a schematic side sectional view of the mixing chamber 206 of the present application at the position of the input pipe 207. In one embodiment herein, the rotating blade 6 includes an annular ring 61, an outer side of the annular ring 61 is provided with sub blades 62, a transverse plate 63 is provided on the annular ring 61, magnets (not shown in the figures) are symmetrically arranged at one end of the transverse plate 63 near a Hall sensor 14, and the two magnets are symmetrically arranged on the surface of the transverse plate with the central axis of the transverse plate 63 as the symmetry axis. A protective cover 7 is provided on an outer side of the upper cover bracket 4, and the Hall sensor 14 is arranged inside the protective cover 7. The Hall sensor 14 is powered by the first battery 9 in the base 201. The number of revolutions of the magnets per minute may be displayed through the Hall sensor 14 and the flow velocity of water in the mixing chamber 206 may be determined. Hall sensor 14 adopts existing products.

In an embodiment, a sealing ring is arranged at the junction of the upper cover bracket 4 and the mixing chamber 206 to prevent water from seeping out of the mixing chamber 206. The through hole 5 is crescent-shaped, the crescent-shaped through hole 5 is matched with the one end of the liquid outlet pipe 208, that is, the liquid outlet pipe 208 also has a crescent-shaped end, and the crescent-shaped through hole 5 and the one end of the liquid outlet pipe 208 are sealed and connected.

In one embodiment herein, the toothbrush shell 101 is provided with a button 8 for controlling start and stop of the water pump 103, vibration motor 104, and toothpaste pump 205. A first battery 9 is provided in the base 201 for supplying power to the toothpaste pump 205, and a second battery 10 is provided in the toothbrush shell 101 for supplying power to the water pump 103 and the vibration motor 104.

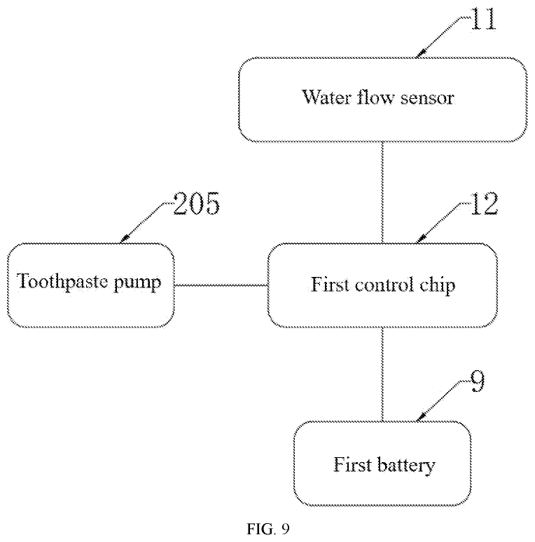

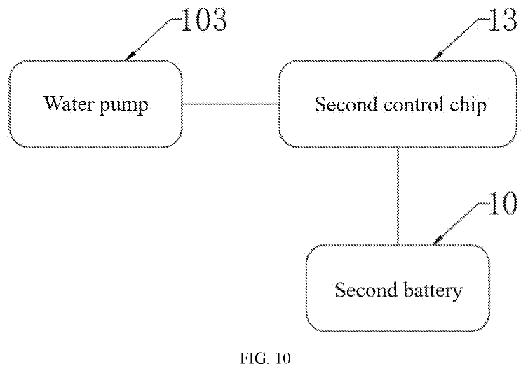

As shown in FIG. 9 to FIG. 10, in an embodiment, the dental cleaning device further includes a water flow sensor 11 and a first control chip 12, where the water flow sensor 11 is arranged on the water inflow port of the three-way valve 203, the water flow sensor 11 is connected to the first control chip 12, and the first control chip 12 is connected to the first battery 9.

In one embodiment herein, the water flow sensor 11 detects a water flow signal and transmits the water flow signal to the first control chip 12, and the first control chip 12 controls the start and the stop of the toothpaste pump 205 based on a ratio of a working duration of the water flow signal to a preset time value; in another embodiment, the first control chip 12 also controls working power of the toothpaste pump 205 based on an amplitude of the water flow signal, so as to dynamically adjust the mixed concentration of toothpaste and water.

The water pump 103 is connected to a second control chip 13, and the second control chip 13 is connected to the second battery 10. A second control chip 13 controls a frequency and an operating mode of the water pump 103, and the first control chip 12 stores different preset values of a water flow rate and frequency signal; when the first control chip 12 obtains a water flow signal meeting one of the preset values of the water flow rate and frequency signal, the second control chip 13 outputs corresponding control instructions, where the water flow rate refers to the volume of water passing through the water pump per unit time, and the frequency refers to the number of repetitions per unit time.

When brushing teeth, the water-jet electric toothbrush 1 is connected to the third hose 17, the water pump 103 in the water-jet electric toothbrush 1 is started, and then the toothpaste pump 205 is started. The toothpaste pump 205 adopts existing products, such as peristaltic pump or micro air pump. Under the action of the water pump 103, clear water in the water tank 202 enters the input pipe 207 through the first hose 15 and the three-way valve 203, and at the same time, toothpaste in the toothpaste chamber 204 also enters the input pipe 207 through the three-way valve 203 under the action of the toothpaste pump 205, and the mixture of clean water and toothpaste enters the mixing chamber 206 from the input pipe 207 to drive the rotating blade 6 to rotate, so that toothpaste and water may be fully mixed. The mixture of clean water and toothpaste enter the electric toothbrush 1 through the liquid outlet pipe 208 and the third hose 17. The vibration motor 104 is provided with the annular cavity rod 105 penetrating the vibration motor 104, where the annular cavity rod 105 is a tubular rod, and the annular cavity rod 105 is inserted and connected to the perforated toothbrush head 102. Specifically, the annular cavity rod 105 is inserted into the perforated toothbrush head 102 and wrapped in a soft colloid of the perforated toothbrush head 102 to prevent water leakage and facilitate disassembly. The perforated toothbrush head 102 is communicated with the annular cavity rod 105 internally, and the water pump 103 is connected to the annular cavity rod 105 through a pipeline. Water and toothpaste enter the annular cavity rod 105 and pipeline, and then be sprayed out by the nozzle on the electric toothbrush 1. In this embodiment, the vibration motor 104 adopts existing products, such as the model HQ-DJ1638-2 vibration motor 104.

The water pump 103 is started by the button 8, and the water flow sensor 11 is triggered through the water flows. The water flow sensor 11 detects a water flow signal and transmits the water flow signal to the first control chip 12, the first control chip 12 controls the start and the stop of the toothpaste pump 205 based on a ratio of a working duration of the water flow signal to a preset time value, and the first control chip 12 also controls working power of the toothpaste pump 205 based on an amplitude of the water flow signal, so that the handle does not need wireless communication to control the start and the stop of the toothpaste pump 205. For example, when the water flow signal is detected and the working duration of the water flow signal is small, the first control chip 12 controls the start of the toothpaste pump 205, that is, the toothpaste pump 205 is restarted after water passes through to prevent toothpaste from blocking the pipeline. When the working duration of the water flow signal is equal to the preset time value, the toothpaste pump 205 is controlled to be turned off, indicating that the use is finished. In another embodiment, after use, the water pump 103 may be controlled by the second control chip 13, continue to work for a preset time, for example, 10-20 seconds, and water is used for flushing, so as to avoid pipeline blockage and achieve the self-cleaning function with reserved water.

Although embodiments of the present application have been shown and described, it may be understood by those skilled in the art that multiple changes, modifications, substitutions, and variations may be made to these embodiments without departing from the principles and spirit of the present application. The scope of the present application is limited by the accompanying claims and their equivalents.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A dental cleaning device, comprising:
an electric toothbrush and a mixing mechanism, wherein the electric toothbrush is connected to the mixing mechanism;
the electric toothbrush comprises a toothbrush shell and a perforated toothbrush head, wherein the perforated toothbrush head is arranged at a top of the toothbrush shell, a water pump and a vibration motor are arranged in the toothbrush shell, the vibration motor is internally provided with an annular cavity rod penetrating the vibration motor, the water pump is communicated with the annular cavity rod through a pipeline, a top of the annular cavity rod is inserted into a bottom of the perforated toothbrush head and the perforated toothbrush head is communicated with the annular cavity rod;
the mixing mechanism comprises a base, a water tank, a three-way valve, a toothpaste chamber, a toothpaste pump, and a mixing chamber; the mixing chamber is arranged in the base, and the mixing chamber is respectively provided with an input pipe and an liquid output pipe; the water tank is arranged at a top of the base, the water tank is internally provided with a water outlet, and the water outlet is connected to a water inflow port of the three-way valve through a first hose;
the toothpaste chamber is arranged in the base, a discharge port of the toothpaste chamber is connected to an input end of the toothpaste pump, and an output end of the toothpaste pump is connected to a toothpaste inflow port of the three-way valve through a second hose; an outflow port of the three-way valve is connected to the input pipe of the mixing chamber, and the electric toothbrush is arranged on the base.

2. The dental cleaning device of claim 1, wherein the upper cover bracket is arranged on the mixing chamber, and a surface of the upper cover bracket is provided with a through hole, one end of the liquid outlet pipe is connected to an inside of the mixing chamber through the through hole, an other end of the liquid outlet pipe is connected with a third hose, and the third hose is connected to an input end of the water pump.

3. The dental cleaning device of claim 2, wherein the inner side of the upper cover bracket is rotatably connected to a rotating shaft, and an end of the rotating shaft is connected to a rotating blade.

4. The dental cleaning device of claim 3, wherein the rotating blade comprises an annular ring, an outer side of the annular ring is provided with sub blades, a transverse plate is provided on the annular ring, magnets are symmetrically arranged at one end of the transverse plate near a Hall sensor, a protective cover is provided on an outer side of the upper cover bracket, and the Hall sensor is arranged inside the protective cover.

5. The dental cleaning device of claim 1, wherein the toothbrush shell is provided with a button for controlling start and stop of the water pump, vibration motor, and toothpaste pump.

6. The dental cleaning device of claim 5, wherein the first battery is provided in the base for supplying power to the toothpaste pump, and a second battery is provided in the toothbrush shell for supplying power to the water pump and the vibration motor.

7. The dental cleaning device of claim 6, wherein the dental cleaning device comprises a water flow sensor and a first control chip, wherein the water flow sensor is arranged on the water inflow port of the three-way valve, the water flow sensor is connected to the first control chip, and the first control chip is connected to the first battery.

8. The dental cleaning device of claim 7, wherein the water flow sensor detects a water flow signal and transmits the water flow signal to the first control chip, the first control chip controls the start and the stop of the toothpaste pump based on a ratio of a working duration of the water flow signal to a preset time value, and the first control chip also controls working power of the toothpaste pump based on an amplitude of the water flow signal.

9. The dental cleaning device of claim 1, wherein the water pump is connected to a second control chip, and the second control chip is connected to the second battery.

10. The dental cleaning device of claim 1, wherein the second control chip controls a frequency and an operating mode of the water pump, and the first control chip stores different preset values of a water flow rate and frequency signal; when the first control chip obtains a water flow signal meeting one of the preset values of the water flow rate and frequency signal, the second control chip outputs corresponding control instructions.
